(19) United States
(12) Patent Application Publication
(10) Pub. No.: US 2015/0373504 A1
(43) Pub. Date: Dec. 24, 2015

(54) USER CONTEXT NETWORK SYSTEM AND METHOD

(71) Applicant: Wonder Tech Co., San Francisco, CA (US)

(72) Inventors: Andrew Grinalds, San Francisco, CA (US); Julian Okuyiga, San Francisco, CA (US)

(21) Appl. No.: 14/746,747

(22) Filed: Jun. 22, 2015

Related U.S. Application Data
(60) Provisional application No. 62/015,335, filed on Jun. 20, 2014.

(51) Int. Cl. H04W 4/04; H04W 24/02; H04W 4/02

(52) U.S. Cl. CPC H04W 4/043; H04W 4/028; H04W 24/02

(57) ABSTRACT

A user context system and method are provided. The system may define a user context and then one or more rules based on that device and those connected on the context of the user. The system may also have an orbit user interface that displays the users who context has been distributed by the system.

### PRIORITY CLAIMS/RELATED APPLICATIONS

This application claims priority under 35 USC 120 and the benefit under 35 USC 119(e) to U.S. Provisional Patent Application Ser. No. 62/015,335 filed on Jun. 20, 2014 and entitled “User Context Network System and Method”, the entirety of which is incorporated herein by reference.

### FIELD

The disclosure relates generally to a system and method for determining and persisting user context across various applications on a computing device.

### BACKGROUND

Disruptions and distractions from mobile phones are a modern pain point. The root cause is a lack of visibility (from the contactor's perspective) on what is going on at the other end of the phone. It becomes the burden of the person being contacted to respond to and coordinate incoming messages, thereby pulling them out of their present engaged activity and onto their phone. The mobile user may be engaged in any number of different contexts—which cannot easily be predicted or inferred by the person who is trying to contact the mobile user. In addition, a mobile user cannot predict what or who is on the other end of the phone. These problems for the mobile user or person contacting the mobile user exist because current systems and device do not provide reliable context about the mobile user.

There is a class of communication problems related to disruptions and distractions -the biggest breakdown of this type is distracted driving. Texting or phone calls and driving (distracted driving) is becoming one of the United States' biggest problems and resulted in approximately 1.3 million car accidents in 2011. Among teenagers, the problem has become a greater hazard than even drinking and driving. In addition, with the wider adoption of mobile computing devices, such as smart phones, the number of fatalities is projected to skyrocket.

Currently there are a number of systems that are designed to prevent distracted driving. The majority of the existing solutions are smart phone applications that disable the phone while driving. The existing solutions use either GPS or data from the accelerometer to detect driving. Other solutions involve having the car specifically send out a signal to the phone and this signal will then cause the phone to be disabled while driving.

The limitation of these existing solutions is that they do not solve the fundamental visibility issue and are therefore incomplete. Without proper visibility it is impossible to provide social accountability, incentivize users to change their behavior. Until the person who is contacting is able to receive the context that someone is driving, the question will always remain.

### BRIEF DESCRIPTION OF THE DRAWINGS

FIG. 1 illustrates an implementation of a user context system;

FIG. 2 illustrates more details of an implementation of a computing device that is part of the user context system;

FIG. 3 illustrates more details of an implementation of a backend that is part of the user context system;

FIG. 4 illustrates a method for determining and distributing user context using the user context system;

FIG. 5 illustrates a method for determining a user interface of the computing device;

FIGS. 6A and 6B illustrate an example of a home screen user interface of the computing device with the context app;

FIGS. 6C-6E illustrate an example of a user interface for selecting a context icon and an expiration time of the context of the user;

FIG. 6F illustrates an example of a user interface for entering a text description of the user context;

FIG. 7A illustrates an example of a user context display user interface of the computing device with the context app;

FIG. 7B illustrates another example of a user context display user interface of the computing device with the context app;

FIG. 8 illustrates an example of a messaging app user interface of the computing device with the context app; and

FIG. 9 illustrates another example of a messaging app user interface of the computing device with the context app.

### DETAILED DESCRIPTION OF ONE OR MORE EMBODIMENTS

The disclosure is particularly applicable to a client server system that determines and distributes user context to one or more Apple iPhone products as illustrated below and it is in this context that the disclosure will be described. It will be appreciated, however, that the system and method has greater utility, such as to other computer architecture implementations of the system, different applications that can interface with the user context system and different computing devices, such as Android operating system products, that can be used with the user context system.

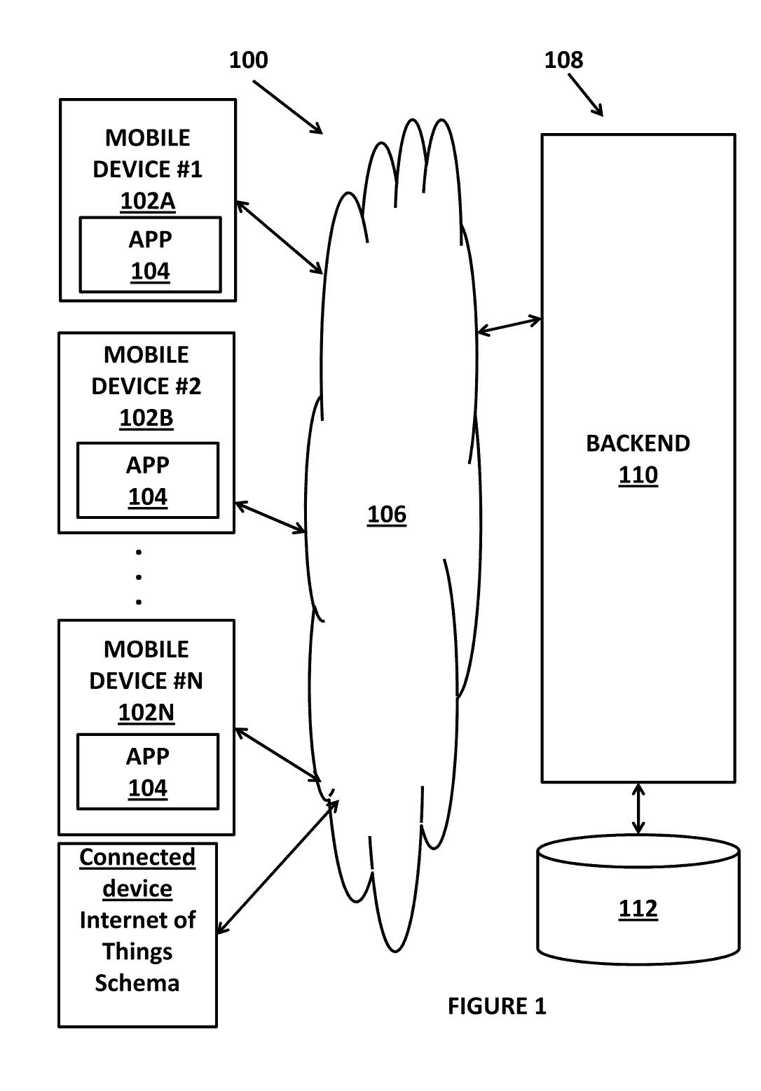

FIG. 1 illustrates an implementation of a user context system 100 that determines and then distributes the context of each user of the system. In one exemplary use, the user context system may be used to distribute the context of a user, such as driving in a vehicle, and then combat distracted driving by showing that the user is currently driving and should not be contacted as well as setting the expectation that they will not receive calls or messages while the user is driving. The system may provide an incentive to the user to use the system to prevent distracted driving which is that the system provides the user with a context of mutual contacts and then allows the user to predict whether communication will be successful. This context information persists across the applications resident on the computing device because the system creates a dynamic context field in front of the contact name that may be relied upon by other applications. The user context system may also be used to more generally distribute the context of the user, persist that user context across the applications on the computing device and permit the user to launch an application (app), such as for example a messaging app, from the user context directory display as described below in more detail. A user may also create a group context, and include a text descriptor such as an event name, and include the members of that event, the names of mutual contacts which are a part of that group are viewable in the application. A group message may be initiated amongst those members and serve as a private record of the event with pictures, videos and text.

The system 100 may have one or more computing devices 102, such as mobile device #1 102A, mobile device #2 102B, . . . , mobile device #N 102N and/or a connected device and an internet of things schema as shown in FIG. 1, that are capable of connecting over a communications path 106 to a backend system 108. The computer system architecture shown in FIG. 1 is a client/server type architecture, but the system 100 may be implemented using other computer system architectures that are within the scope of the disclosure. Each computing device 102 may be a processor based device that is capable of connecting to and communicating over the communications path 106 with the backend system 108, interacting with the backend system 108, and displaying one or more user interface screens or schema actions resulting from contextual data created by 102, processed at 110 and generated by a context app 104 that is executed by each computing device. The context app 104 may be downloaded to the computing device, already resident on the computing device, downloaded from an application store or otherwise provided to the computing device so that the context app may be stored in the computing device and then executed by the processor of the computing device. Each computing device may be a tablet computer, a computing device with phone or messaging capabilities, or other computing device. In one implementation, each computing device may be a smartphone device, such as an Apple® iPhone® or an Android® operating system based device.

The context app 104 may, among other functions as described below in more detail, determine a context of the user, provide a context based directory user interface, block communication in certain contexts, such as while driving, communicate schema actions (for example, if this event/fact/data, etc. then take a particular action) to other connected devices and allow the user to launch other application on the computing device from the context app. In one implementation of the system, the context app may call application programming interfaces (APIs) on the backend system 108. One implementation of a context based schema is a mechanism that manages a list of allowed callers. This list is null (i.e. no allowed callers) while driving, or when the user indicates they are not going to be available, and full of contacts otherwise. Specifically, based on the platform the context app is running on, the context app will leverage existing operating system features to block the communications. On Apple iOS, the context app will leverage iOS's Do Not Disturb Mode to manage which communications come to the user. On Android OS based devices, the context app can block communications directly by accessing the native APIs that control communications. The system may use one or more sensors that generate sensor data that may be ambiently collected and processed in the background to automatically provoke an action on behalf of the client based on the sensor data. This ability to automatically provoke the action (a set it and forget it behavior) allows the user to relieve himself of the duties of dealing with lower level system functioning such as providing the context of the user to other users.

The communications path 106 may be a wired or wireless communications path and each computing device may use communication circuits to connect to the communications path 106 using a known protocol and then communicate with the backend system 108 using known secure or unsecure protocols, such as HTTP or HTTPS. For example, the communications path 106 may be the Internet, Ethernet, a wired computer network, a wired communications network, low power Bluetooth network, Near Field Communications network, RFID network, a cellular digital data network, a WiFi network, an SMS network, a wireless computer network, a wireless communications network or a combination of the these networks. Note that when the application of the computing device 102 is communicating with another user, the computing device may connect to the communications path 106 and then communicate with a different backend system (not shown in FIG. 1) to perform the communications or other operations.

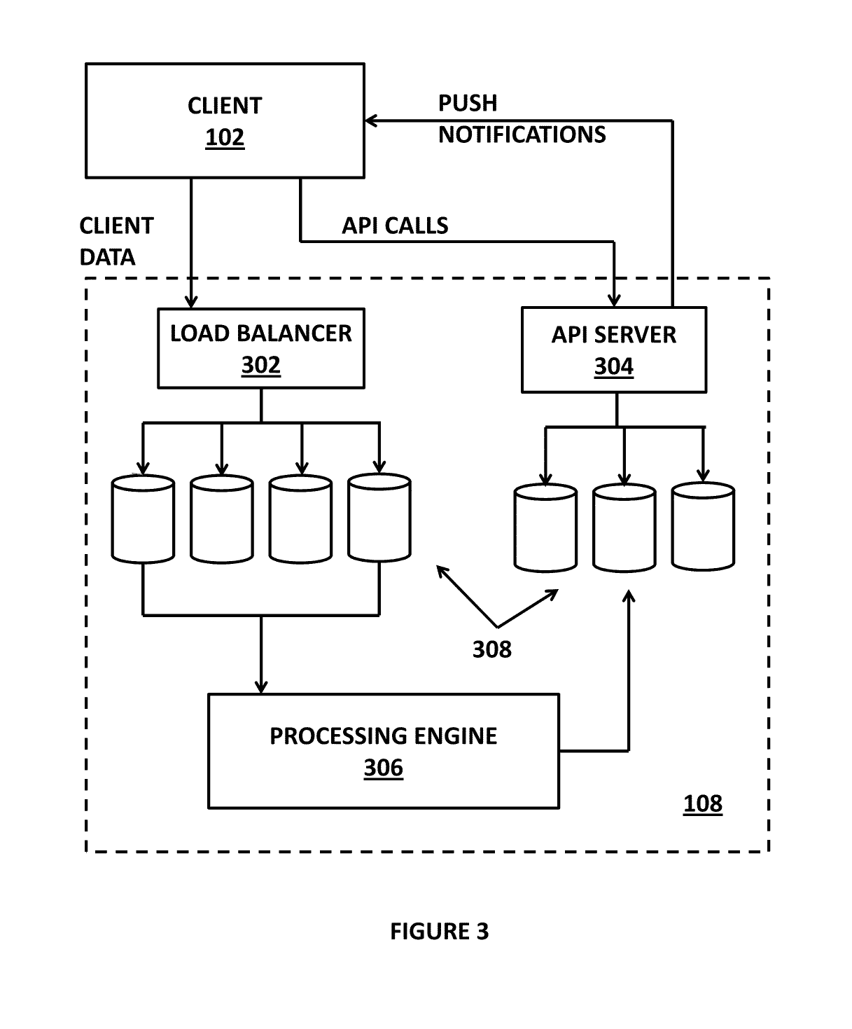

The backend system 108 may further have a backend component 110 and a store 112 that is connected to the backend component 110. The backend component 110 may be one or more computing resources that implement the functions of the backend component 110 described below. For example, the one or more computing resources may be one or more server computers or one or more cloud computing resources (each of which may include one or more processors, memory, etc.) that implement the elements shown in FIG. 3 and described in further detail below. The store 112 may be a hardware based storage system or a software based storage system or a combination of these that store user data of the system and other data associated with the user context system.

In the user context system 100, the context of each user of the system (described below in more detail) is determined and broadcast to other users of the user context system 100. The user context system 100 may store the context of the user in a contact book (such as in the store 112 or in storage in the computing device.) In the user context system 100, the context of each user may only be distributed to mutual contacts of the user so that the context is not distributed to every user. Using the user context system 100, the context of each user persists across all apps on the computing device. As a result, the user of each computing device may launch another application, such as an over the top messaging application, and then perform an action using the other application while benefiting from added context created by app 104.

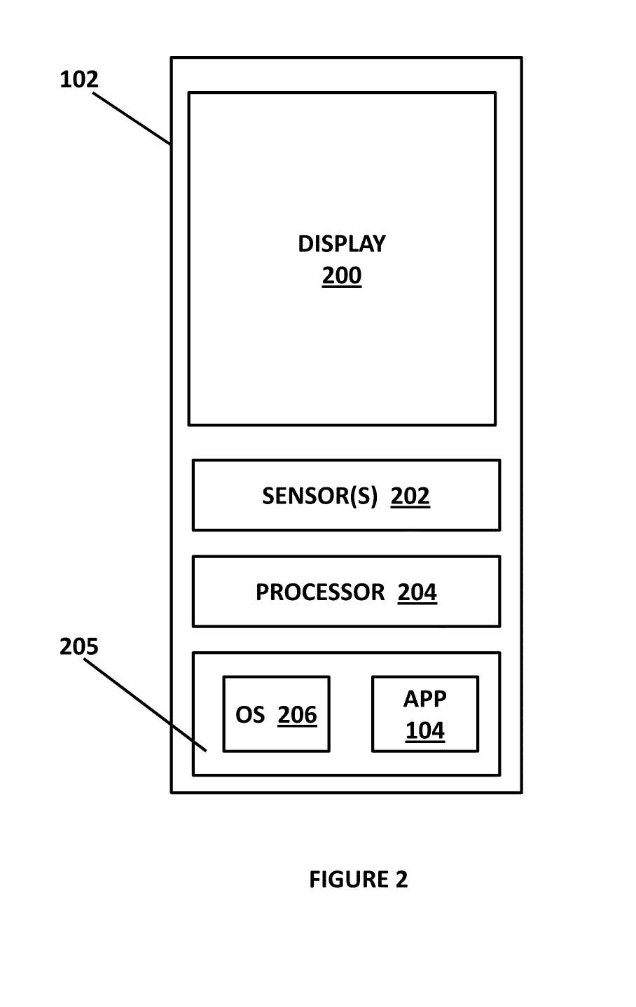

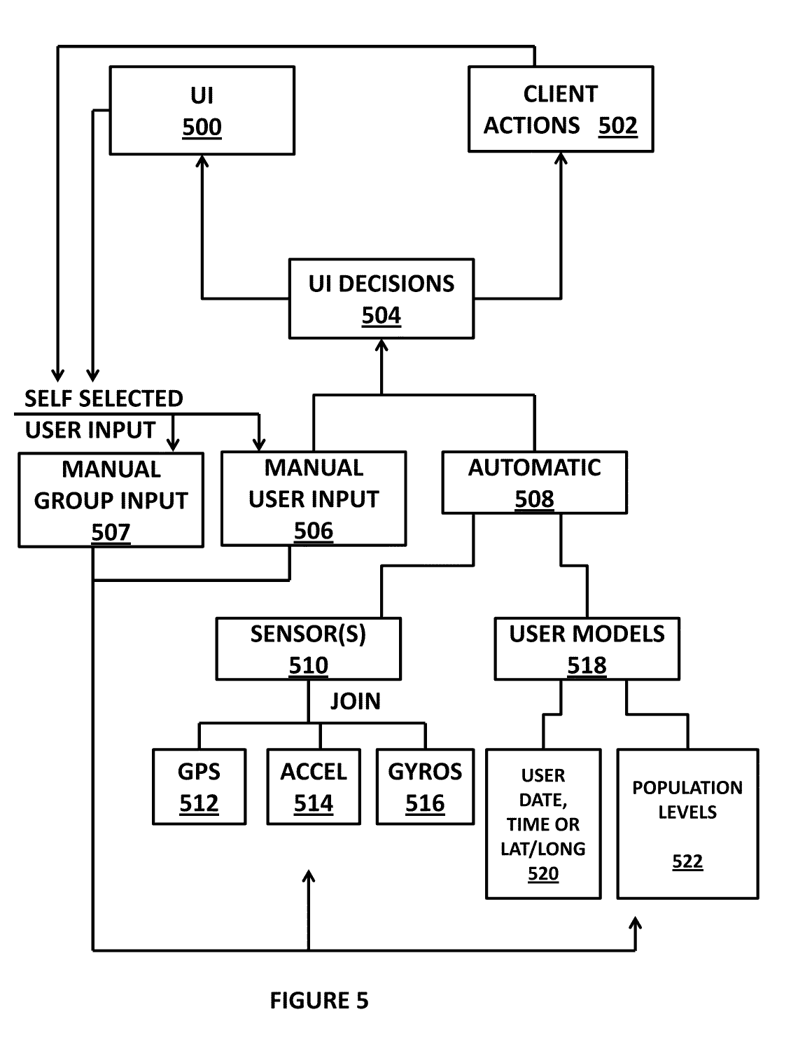

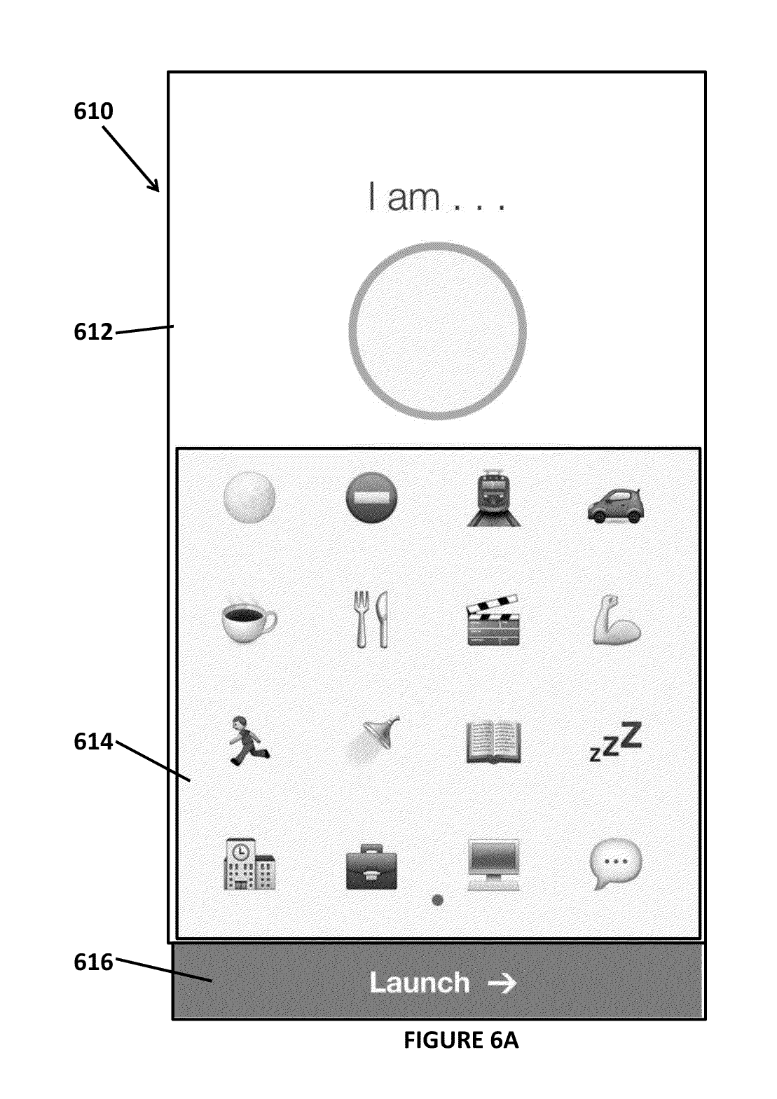

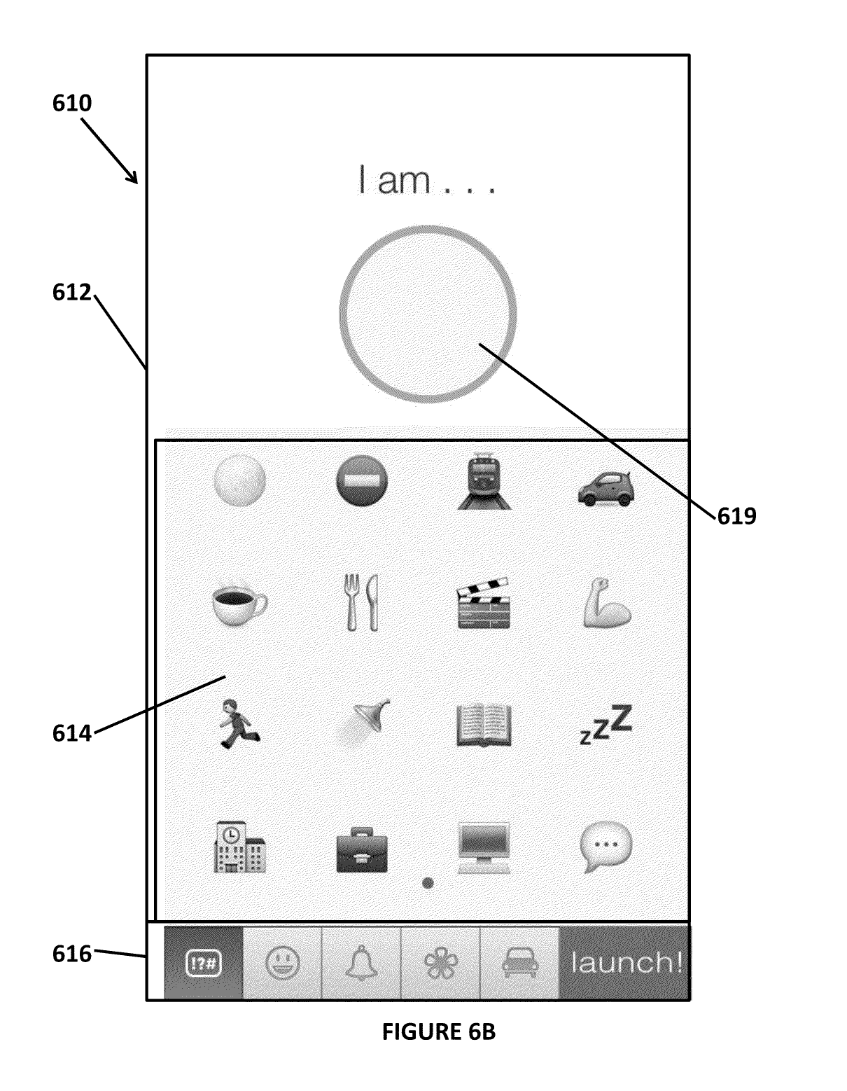

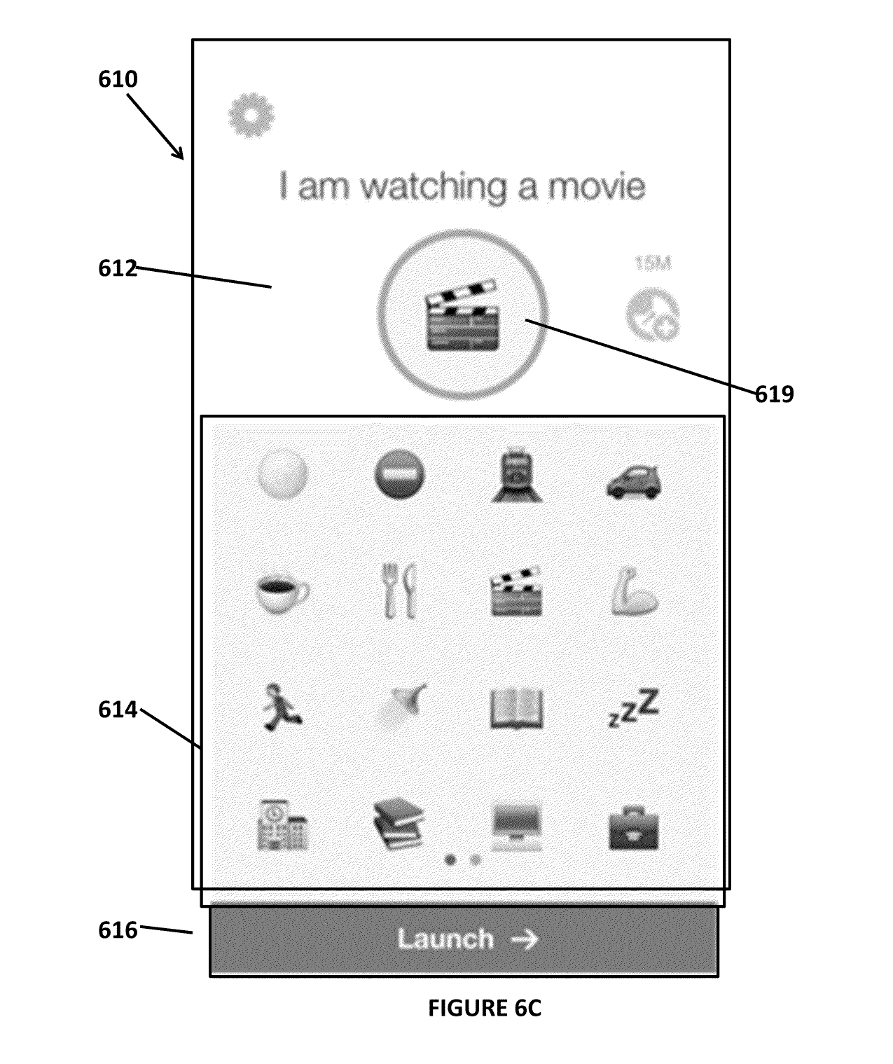

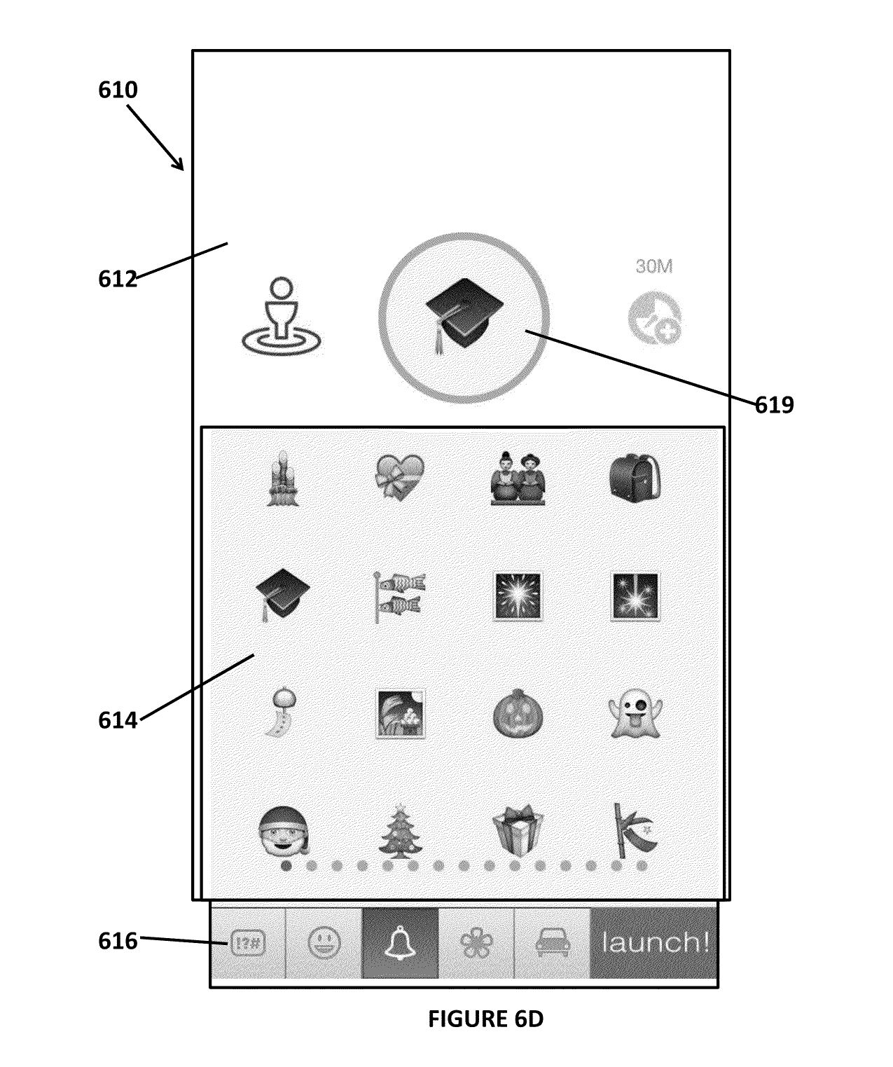

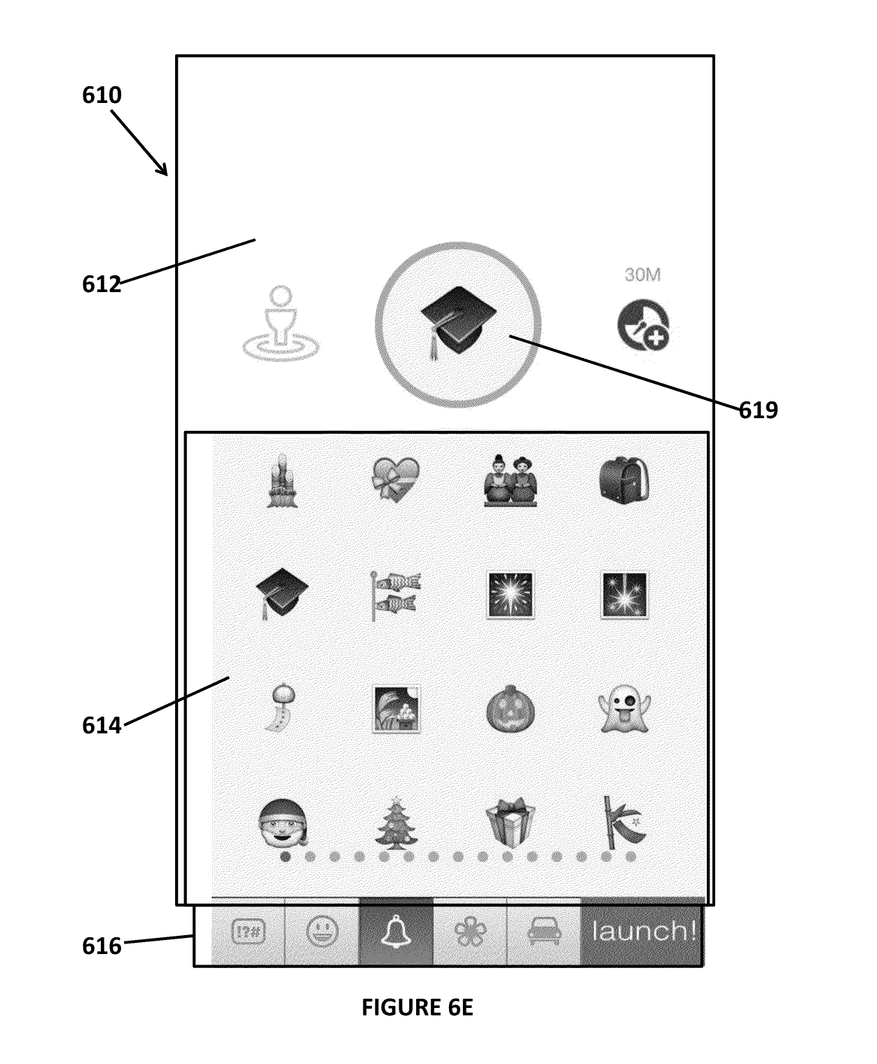

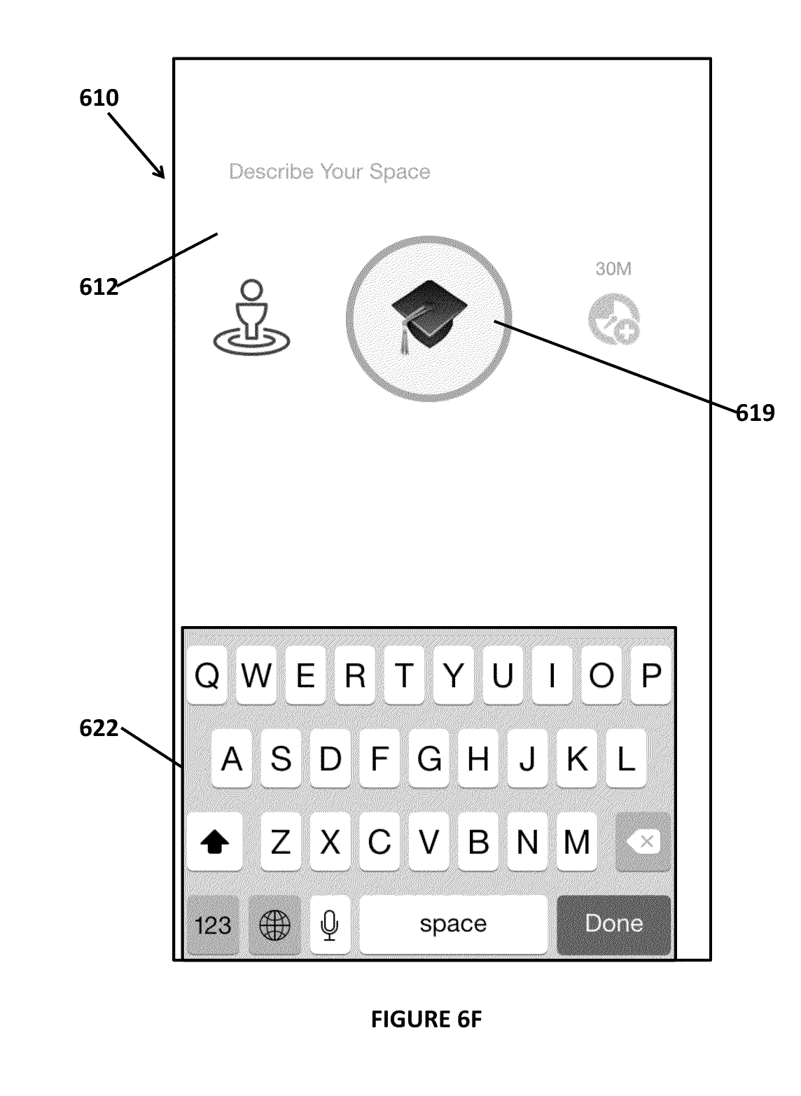

FIG. 2 illustrates more details of an implementation of a computing device 102 that is part of the user context system 100. The computing device 102 may have a display 200, such as an LCD, that may be a display or a touchscreen display, one or more sensors 202 and a processor 204. The display 200 may display the user interface of the user context app (examples of which are shown in FIGS. 6A-8) based on data sent from the processor. The one or more sensors 202 may be one or more sensors that may be used to determine the context of the user. For example, as shown in FIG. 5, the one or more sensors may be one or more of a location sensor, such as GPS or GLONASS, etc., a sensor for determining an acceleration of the computing device in one or more axes, such as an accelerometer, a sensor for determining an orientation/rotation of the computing device in one or more axes, such as a gyroscope or other types of sensors including a magnetometer, a temperature sensor, a humidity sensor, a relative humidity sensor and/or a direction sensor, such as a compass. For example, the different types of sensors that may be used with an Android OS based device are summarized at http://developer.android.com/guide/topics/sensors/sensors_overview.html (which is incorporated herein by reference.) The one or more sensors may further include a gravity sensor that measures a force of gravity that is being applied to the device, a light sensor that measures the ambient light near the computing device, a linear acceleration sensor that measures the acceleration of the computing device in one or more axes excluding the force of gravity, a magnetic field sensor that measures the magnetic field at/near the computing device in one or more axes, a pressure sensor that measures an ambient air pressure at/near the computing device, a proximity sensor that measures the proximity of an object to the computing device and/or a rotation vector sensor that measures the orientation of the computing device based on the three elements of the computing device's rotation vector. In the system, the one or more sensors may also be other known or yet to be developed sensors that may be used by the app 104 to trigger an action.

The computing device 102 may also have wireless or wired communication circuits or software that allow the computing device 102 to connect to the communications path 106 and communicate with various external systems, such as a the backend system 108, over the communications path 106. The processor 204 may be electrically connected to the display 200, communication circuits and the one or more sensors 202.

The computing device 102 may also have storage 205 that is coupled to the processor 204 wherein the storage 205 may be temporary storage, such as SRAM or DRAM, or persistent storage, such as FLASH memory, a disc drive, etc. The storage 205 may store an operating system 206 and the context app 104 as shown. The storage may also store one or more apps that may be executed by the processor 204 or one or more apps that may be downloaded into the storage. As described above, the storage 205 may also store the context information for the user so that the context information persists across the apps executed by the computing device.

FIG. 3 illustrates more details of an implementation of a backend 108 that is part of the user context system that includes the client/computing device 102. As shown in FIG. 3, the backend component 108 may further comprise a load balancer 302, an API server 304, a processing engine 306 and one or more storage devices 308. For example, the API server 304 may be a Node.js API server using standard HTTP. For the implementation with the Apple computing devices, the Node.js server may communicate with Apple Push Notification Service (APNS) Google Communication Manager (GCM) or a company owned socket connection. The one or more storage devices 308 may be hardware based storage or software based storage or a combination. The backend component 108 may also have an authentication/verification component (not shown) that is used to verify the use of each context app by each computing device. Each of the components of the backend component 108 may be implemented using one or more computing resources wherein the one or more computing resources may be one or more server computers or one or more cloud computing resources (each of which may include one or more processors, memory, etc.) Alternatively, each of the components of the backend component 108 may be implemented in hardware, such as a programmable logic device, a microcontroller, an ASIC and the like. As shown, the data from each computing device (client data as described in more detail below with reference to FIG. 5) may be communicated to the load balancer 302 (that may be implemented using node.js and socket.io, for example) that stores the client data for the particular computing device into the storage devices 308. The processing engine 306 may obtain some portion of the client data from the storage device 308 and may use the client data for the user context functions of the backend component 108 as described below in more detail. The processing engine 306 may store data into the storage devices 308 that may be context information for the particular computing device or rules about the context of the particular computing device as described below. The API server 304, using in part the data stored in the storage device 308, may receive an API call from the computing device 102 and then communicate push notifications to the computing device 102 based on data and the API calls. The API server 304 may be implemented in various ways. For example, the API server 304 may be maintained by the company that owns the app or by a third party, such as Apple Computer (APNS) or Google (GCM).

An example of an API call may be as follows: Each user posts a http GET request to http://strivespace.com/api/friend with their unique user token and receives a JSON response containing the individual and group context information for their mutual contacts on the application. This dynamic context icon then updates the name field of their global contact book directory.

In operation, the system initially may verify that the app is installed on the computing device and then verify the type of computing device being used (iOS vs. Android, for example.) The system may also sign up or confirm that the user of the computing device is a user of the system. Once the verification has been completed, the system may also upload a contact book of the user to the system so that the system may be implemented.

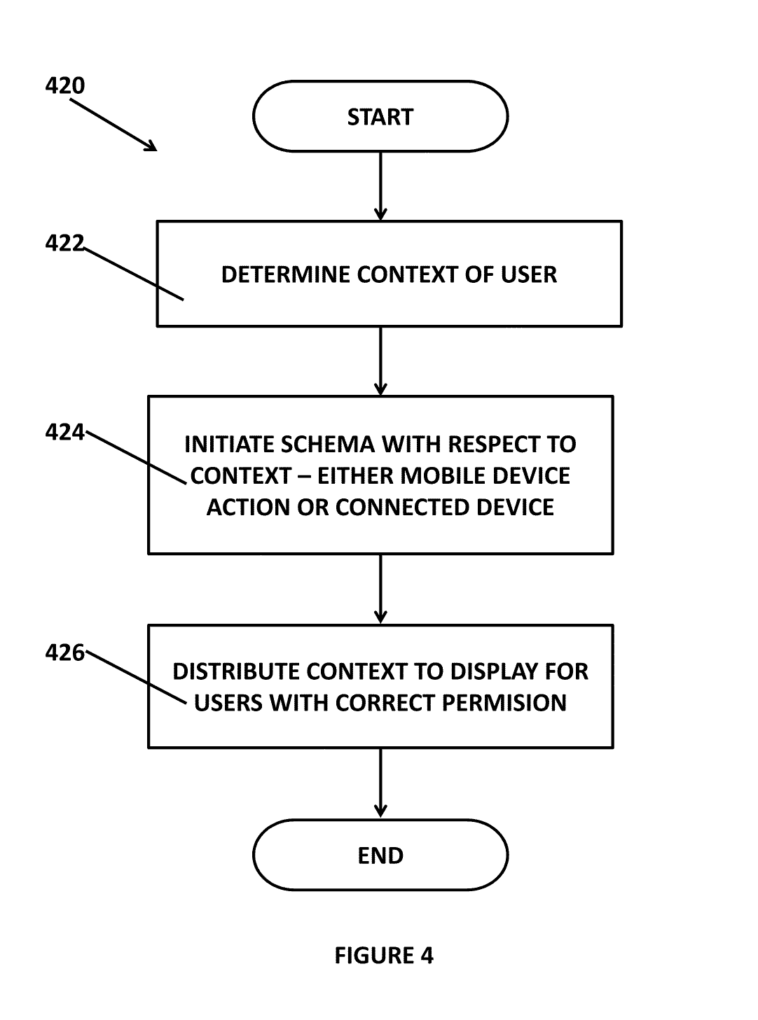

FIG. 4 illustrates a method 420 for determining and distributing user context using the user context system. The method in FIG. 4B may be implemented using the components of the backend component and the computing device. The system may determine using a statistical machine learning model—such as an SVM (state vector machine) (or may have already determined) a context of the user (422) based on user input and/or data about the context of the user and/or data from the one or more sensors 202 and/or data from the user models. For example, the system may determine that the user is driving in a vehicle or is attending church. Each of these contexts may also include one or more rules (the schema), such as no texting or phone calls while the user is driving or no texting, phone calls or other communications while the user is in church. Thus, the system may initiate the appropriate schema (424) based on the user context (either based on a computing device action or based on the connected device.) Once the user context has been determined (or is already known) and the rule schema applied, the system may distribute context of the user of the computing device (426) to other user of the system (but only mutual contacts of the user) and the context may persist across the application that are executed on the computing device. Thus, each other user of the system who has a mutual contact with the particular user may see a context icon, such as an emoji, that indicates the context of the user. As part of the persistence of the context information, the group context information for each user may be displayed in an orbit (an example of which is shown in 7). Using the orbit display to select another user (or another method), an application may be launched to communicate with the other users.

FIG. 5 illustrates a method for determining the contextual display via user interface of the computing device. In the method, a user interface (UI) 500 and client actions 502 may be determined based on UI decisions 504 of the context app and/or the backend component. The UI and client actions may then allow the user to input data as manual user input 506. The manual user input 506 may be used to affect the determination of the user context. The UI decisions 504 may also be based on automatic input 508 that may also determine the context of the computing device. The automatic input may include sensor input 510 and user models 518. The sensor input 510 may be, for example, the sum of one or sensors such as a GPS sensor 512, an accelerometer 514 and a gyroscope 516. The system may utilize various sensors and sensor inputs and the system is not limited to the sensor or sensor inputs shown in FIG. 5. The user models 518 may include, for example, user date, time and latitude/longitude data 520 and/or population levels of particular user inputs sorted by location 522. Population levels specifically refer to contextual tags and their associated time stamps, geotags that are tied to a particular user post, time and location. By aggregating this information over the population of users and running machine learning algorithms, the context app will be able to offer a confidence interval to predict the expected context of the user at that particular location and time. Using these pieces of data, the system may determine the context of the user.

For example, using the population levels, the system may use a statistical model to determine the context of the user. In one implementation, the system may use a “bag of words” algorithm in which based on prior historical sampling of the population levels, the system may construct a Baysian model to determine a likelihood of one or more contexts for the user.

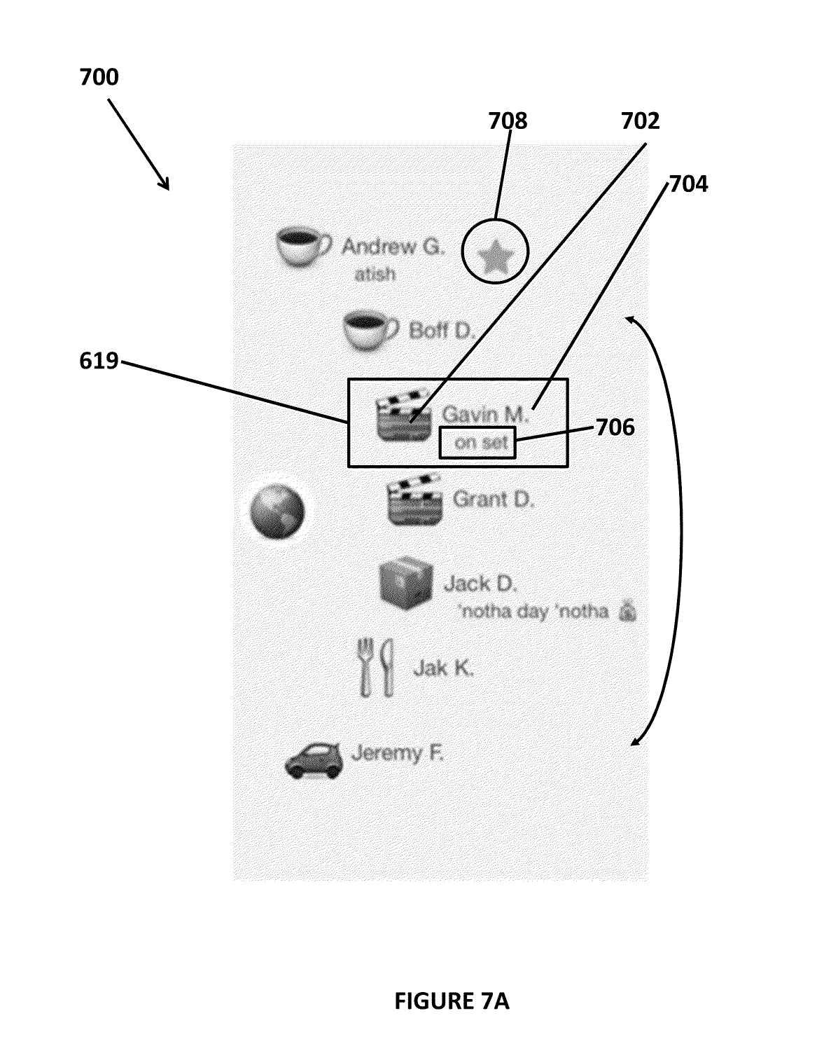

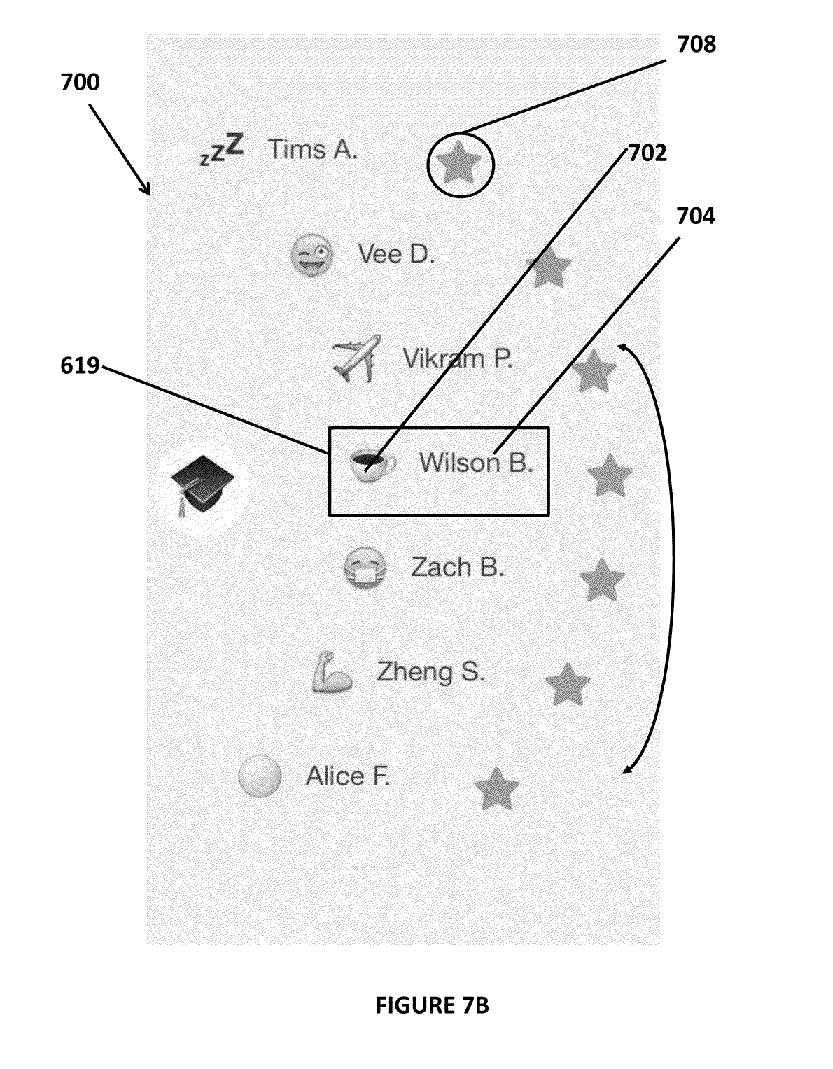

As another example, the system may use the latitude/longitude data (geolocation) of the user and geofencing in a regressive partitioning model. In the model, the system may associate one or more contexts to predictive physical locations. For example, when the user is in a location where there isn't population level data, the system can predict, based off available tagged geography from google, apple, open street maps etc., the context of the user. For example, if the user is located near/at a church for a period of time, the user's context is attending church. In addition, the system may suggest a context of the user (contextual tags) that may fit the location of the user even if the system does not a lot of data about the user or from the user models. In the above method in FIG. 5, the system determines a confidence interval to determine which dynamic context icon should be shown in the field in front of the contact name for each user (an example of the user interface is shown in FIGS. 7A and 7B.) In addition, the system may both ambiently display some context icons for the user and then also group some relevant icons for the user to choose—on the UI broadcast screen 500. For example, a group member may tie 5 people together into a car trip and it will be clear using the app that they are all driving. Using the context system, the context of the user may be determined based on the user input (such as selecting the context icon as shown in FIGS. 6A-6E) or automatically based on the sensor data or user models. The sensor data may for example indicate that the computing device (and thus the user) is moving and therefore driving. The user model may indicate that the user normally attends church on Sunday from 10 AM-noon and would switch the context of the user to church during that time. Another example could be when the user leaves their home, the context app will be able to notify connected devices such as lights and door locks through API calls to the servers of those connected devices. Additionally since the context app will gather GPS location, if the user goes to a coffee shop or to the gym it can again switch context ambiently. Similarly this will work also if the user is at school or at home.

FIGS. 6A and 6B illustrate an example of a home screen user interface 610 of the computing device with the context app. The home screen may have a display portion 612 that asks the user to enter their current context. The home screen also has a context icon area 614 that allows the user to select a context icon for the user at the particular time from a plurality of context icons. The user may browse through the plurality of context icons. In one implementation for the Apple iPhone, each context icon may be an emoji, but may also be other types of context icons. The user may change their context at any time and then the context icon may change and the changed context may be distributed.

In the context app, each context icon may have one or more rules associated with the context icon. Each rule may define an action that occurs when the user selects (or the system selects) the context icon of the user. For example, a rule may be that, when the driving context icon is used, texting and phone calls are not permitted. The rules may also define other actions based on the context of the user. Another rule might be if the user is at church, the mobile device will allow messages but not ring or buzz. If the user is in class, the context app might then also text message an incoming caller that the user will respond after class is over. The home screen 610 may also have a command tray 616 that provides a number of commands that the user may select. The tray should also show a list of the most likely status to post based on user, location and time of device. Group membership and text descriptors may also be shown here. Other rules may also be displayed here. The user interface also may have a button to clear status and a button to add a set of friends to your context (and create a group) will display here.

The system, as described, may generate the context icon for the user (also known as an emoji) and then a context icon/emoji 619 may be displayed in the various user interfaces of the system such as shown for example in FIGS. 6A-6F and 7A and 7B. In the system, such as in the example user interfaces in FIGS. 6A-6F, the emoji 619 of the user at any particular time may be used until it is changed by the user. Alternatively, the system may also allow the user to set their emoji 619 to expire automatically, for example as shown in FIG. 6E. For example, the emoji 619 may expire in a predetermined time period (for example, at the end of the day or after 3 hours for a movie, etc.) or the emoji may expire when the user moves a certain distance (makes a significant geo move based on geofencing (for example, expire a “at movies” emoji once the user is two blocks away from the movie theater, etc.) In addition, as shown in FIG. 7A described below, each emoji may include a piece of text (for example, “on set” as shown in FIG. 7A) that provides more context about the user.

FIGS. 6C-6E illustrate examples of a user interface for selecting a context icon and an expiration time of the context of the user that has the display portion and context icon portions and the command tray. The user is able to create a group of users and the user interface may have a little reel that shows the associated emoji from each member of the group. The user may also be able to see a text tag for the group description. In some embodiments, the number of members of the group may be limited to 10 and the names of those that you are mutual contacts with currently. As shown in FIG. 6C, the user may select a geofence feature so that the emoji 619 and its message (“I am watching a movie”) expires after the user moves a predetermined distance or changes location as described above. FIG. 6D shows the user selecting a context icon 619 (graduation) and FIG. 6E shows that a 30 minute expiration period has been set by the user. FIG. 6F shows an example of a user interface in which the user may enter a piece of text to be associated with the context icon using an input device 622.

FIGS. 7A and 7B illustrate examples of a user context display user interface 700 of the computing device with the context app. The user interface may be an orbit of the users that are sharing their contexts with the user (due to mutual contacts.) As shown by the double ended arrow, the user who have contexts (shown by the context icons) may orbit elliptically around an icon representing the user of the computing device so that the user can quickly see the user and their contexts. As shown in FIG. 7A, the context icon/emoji 619 may have the context icon 702, a name of the user 704 and a piece of text 706 (selectable by the user) that further describes the context or status of the user. This user interface may also have a favorite indicator 708, such as a star in one example, that identifies a favorite other user of the system. In the system, each user may follow their favorite one or more users and the system then generates and sends push notifications each time the status of a user (who is designated as a favorite by the user) changes. Thus, the system automatically updates the context/status of the users of the system.

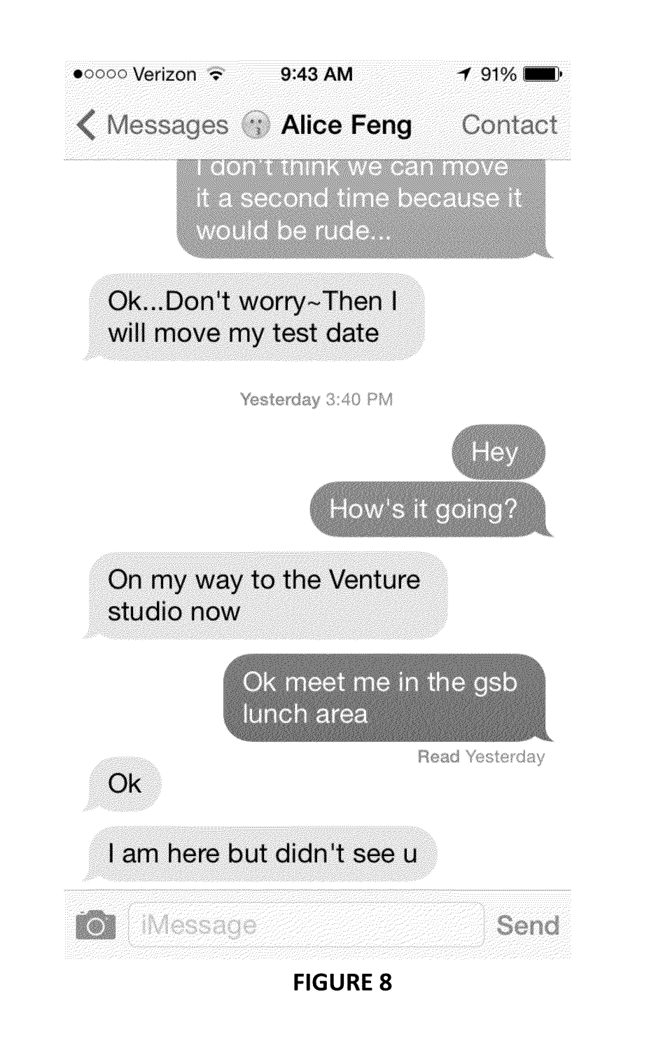

From this user interface, since the contexts of the users is persistent across some/all of the apps of the computing device, the user may select a user and launch an application, such as a messaging application as shown in FIG. 8, that allows the user to use the application. For example, the user may communicate with the other user as shown in FIG. 8. Since the user context persists across some/all of the apps of the computing device, the user of the computing device may use any of those apps and have the benefit of the contextual information about the user in addition to the messaging app example shown in FIG. 8.

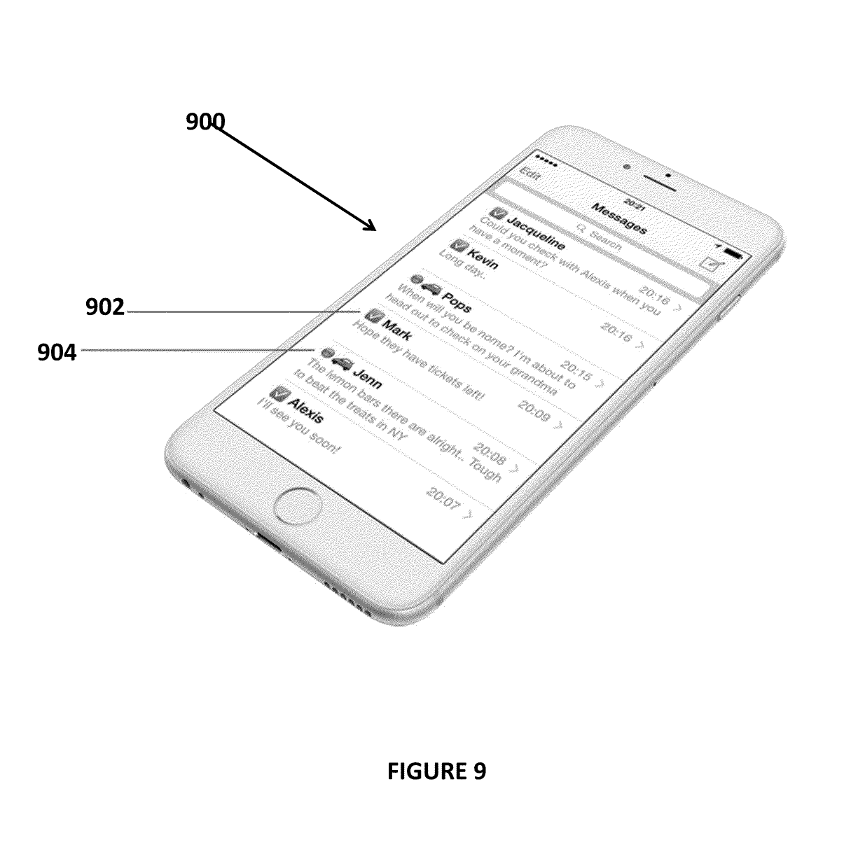

FIG. 9 illustrates another example of a messaging app user interface 900 of the computing device with the context app. As above, since the user context persists across some/all of the apps of the computing device, the user of the computing device may use any of those apps and have the benefit of the contextual information about the user in addition to the messaging app 900. As shown in FIG. 9 for the messaging app 900, an indicator 902 may be displayed that indicates that a particular user, such as Mark, Jacqueline, Kevin and Alexis in the example, are available to be messaged based on the context of those users. The messaging app 900 also may include a second indictor 904 that indicates that the particular user, such as Jenn and Pops, cannot be communicated with since both users are driving per the context of those users. In the system, the second indicator 904 may be slightly different depending on the context of the user. For example, when the user is attending church and thus should not be communicated with, the second indicator 904 may be different that than shown in FIG. 9.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A user context system, comprising:
one or more computing devices, each computing device having a context component;
a backend context component capable of being coupled to each computing device;
the context component determining a current context of the computing device, the current context of the computing device being a state of the computing device during an activity and initiating, based on the current context of the computing device, a context rule to perform one or more actions associated with the computing device, wherein each action changes a function of the computing device while the computing device has the current context;
the backend context component distributing the current context of the computing device to a plurality of other computing devices so that the other computing devices have information about the current context of the computing device.

2. The system of claim 1, wherein the context component persists the current context of the computing device across a plurality of apps capable of being executed by the computing device.

3. The system of claim 1, wherein the context component generates a group context, wherein the group context is the same context for a plurality of computing devices.

4. The system of claim 1, wherein the context component further comprises a context application on the computing device that determines the current context of the computing device and initiates the context rule.

5. The system of claim 1, wherein each computing device further comprises a sensor that generates a sensor signal and wherein the context component determines the current context based in part on the sensor signal.

6. The system of claim 1, wherein the context component uses a model to determine the current context, wherein the model defines the state of the computing device during a predetermined time.

7. The system of claim 1, wherein the content component generates a context icon based on the current context of the computing device.

8. The system of claim 1, wherein the current context of the computing device is a user driving a vehicle and the context rule is blocking texts and calls for the computing device while the user is driving a vehicle.

9. The system of claim 1, wherein the current context of the computing device is a user attending church and the context rule is blocking texts and calls for the computing device while the user is attending church.

10. A method for determining and distributing context on a computing device, comprising:
determining a current context of a computing device, the current context of the computing device being a state of the computing device during an activity;
initiating, based on the current context of the computing device, a context rule to perform one or more actions associated with the computing device, wherein each action changes a function of the computing device while the computing device has the current context; and
distributing the current context of the computing device to a plurality of other computing devices so that the other computing devices have information about the current context of the computing device.

11. The method of claim 10 further comprising persisting the current context of the computing device across a plurality of apps capable of being executed by the computing device.

12. The method of claim 10 further comprising generating a group context, wherein the group context is the same context for a plurality of computing devices.

13. The method of claim 10 further comprising executing a context application on the computing device that determines the current context of the computing device and initiates the context rule.

14. The method of claim 10, wherein determining the current context further comprises receiving a sensor signal and determining the current context based in part on the sensor signal.

15. The method of claim 10, wherein determining the current context further comprises using a model to determine the current context, wherein the model defines the state of the computing device during a predetermined time.

16. The method of claim 10 further comprising generating a context icon based on the current context of the computing device.

17. The method of claim 10, wherein the current context of the computing device is a user driving a vehicle and the context rule is blocking texts and calls for the computing device while the user is driving a vehicle.

18. The method of claim 10, wherein the current context of the computing device is a user attending church and the context rule is blocking texts and calls for the computing device while the user is attending church.

19. A method for determining and distributing user context on a computing device, comprising:
determining a current context of a user of the computing device, the current context of the user being an activity of the user;
initiating, based on the current context of the user, a context rule to perform one or more actions associated with the computing device, wherein each action changes a function of the computing device while the user has the current context; and
distributing the current context of the user to a plurality of other users so that the other computing devices have information about the current context of the user.

20. The method of claim 19 further comprising persisting the current context of the user across a plurality of apps capable of being executed by the computing device.

21. The method of claim 19 further comprising generating a group context, wherein the group context is the same context for a plurality of users.

22. The method of claim 19 further comprising executing a context application on the computing device that determines the current context of the user and initiates the context rule.

23. The method of claim 19, wherein determining the current context further comprises receiving a sensor signal and determining the current context based in part on the sensor signal.

24. The method of claim 19, wherein determining the current context further comprises using a user model to determine the current context, wherein the user model defines an activity of the user during a predetermined time.

25. The method of claim 19 further comprising generating a context icon based on the current context of the user.

26. The method of claim 19, wherein the current context of the computing device is a user driving a vehicle and the context rule is blocking texts and calls for the computing device while the user is driving a vehicle.

27. The method of claim 19, wherein the current context of the computing device is a user attending church and the context rule is blocking texts and calls for the computing device while the user is attending church.
